(19) United States
(12) Patent Application Publication
(10) Pub. No.: US 2015/0135866 A1
(43) Pub. Date: May 21, 2015

(54) SEALED GUARD FOR MOTOR GRADER DRAFT APPARATUS

(71) Applicant: Deere & Company, Moline, IL (US)

(72) Inventors: Dustin T. Staade, Dubuque, IA (US); Nathan J. Hortsman, Durango, IA (US)

(73) Assignee: Deere & Company, Moline, IL (US)

(21) Appl. No.: 14/084,654

(22) Filed: Nov. 20, 2013

(51) Int. Cl. F16H 19/08; E02F 3/84; F16H 57/029

(52) U.S. Cl. CPC F16H 19/08; F16H 57/029; E02F 3/844
USPC 74/89.18

(57) ABSTRACT

A draft apparatus for a motor grader comprises a draft frame, a circle, a moldboard, a circle drive, a guard, and a seal. The circle comprises a circle gear. The circle is connected to the draft frame for rotation relative to the draft frame about an axis of the circle gear. The moldboard is mounted to the circle for rotation therewith about the axis. The circle drive is mounted to the draft frame and comprises a pinion engaging the circle gear to rotate the circle and the moldboard about the axis. The guard depends from the draft frame so as to provide radial cover of the circle gear and the pinion relative to the axis. The seal establishes a sealed connection between the guard and the circle.

### FIELD OF THE DISCLOSURE

The present disclosure relates to a circle of a motor grader.

### BACKGROUND OF THE DISCLOSURE

A motor grader typically has a draft apparatus. The draft apparatus comprises a draft frame and a circle. The circle is connected to the draft frame for rotation relative to the draft frame about an axis of a circle gear of the circle. The moldboard is mounted to the circle for rotation with the circle about the axis. A circle drive is mounted to the draft frame and comprises a pinion engaging the circle gear to rotate the circle and the moldboard about the axis. In some configurations, the circle is connected to the draft frame by use of shoes. The shoes are mounted to the draft frame and extend under the circle gear to support the circle gear for rotation on the bearing/wear inserts of the shoes.

The circle gear and the shoes are exposed to the environment. In this open design, contamination can be introduced into the gear mesh between the pinion and the circle gear and into the interface between the shoes and the circle gear. Such introduction of contamination causes wear in the gear mesh and the shoe-gear interface.

If the gear mesh is worn, backlash (i.e., gap between the faces of the pinion and the circle gear) increases and causes looseness or increased hysteresis when the circle is rotated which is noticeable to the operator. If this continues and the gear mesh is allowed to wear, the circle gear or the pinion or both may need to be replaced.

When the bearing/wear inserts of the shoes are worn, the running clearances increase, which causes looseness in the circle-rotate function. This is noticeable to the operator and can cause a reduction in fine-grading performance. To fix this, the bearing/wear inserts need to be adjusted or replaced.

### SUMMARY OF THE DISCLOSURE

According to an aspect of the present disclosure, a draft apparatus for a motor grader comprises a draft frame, a circle, a moldboard, a circle drive, a guard, and a seal. The circle comprises a circle gear. The circle is connected to the draft frame for rotation relative to the draft frame about an axis of the circle gear. The moldboard is mounted to the circle for rotation therewith about the axis. The circle drive is mounted to the draft frame and comprises a pinion engaging the circle gear to rotate the circle and the moldboard about the axis. The guard depends from the draft frame so as to provide radial cover of the circle gear and the pinion relative to the axis. The seal establishes a sealed connection between the guard and the circle, inhibiting passage of contamination therebetween.

The above and other features will become apparent from the following description and the attached drawings.

### BRIEF DESCRIPTION OF THE DRAWINGS

The detailed description of the drawings refers to the accompanying figures in which:

FIG. 1 is a perspective view showing a draft apparatus for a motor grader;

FIG. 2 is a perspective view showing a circle of the draft apparatus;

FIG. 3 is a sectional view taken along lines 3-3 of FIG. 1; and

FIG. 4 is an enlarged sectional view showing an alternative embodiment of a mounting plate comprising a recess included in a labyrinth.

### DETAILED DESCRIPTION OF THE DRAWINGS

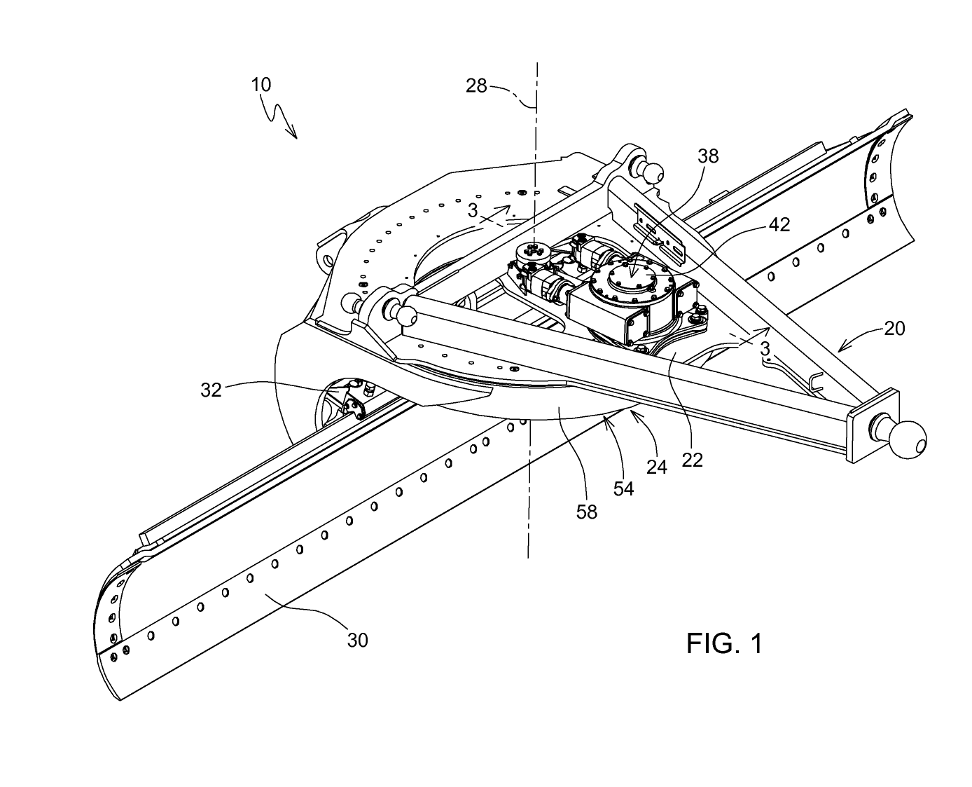

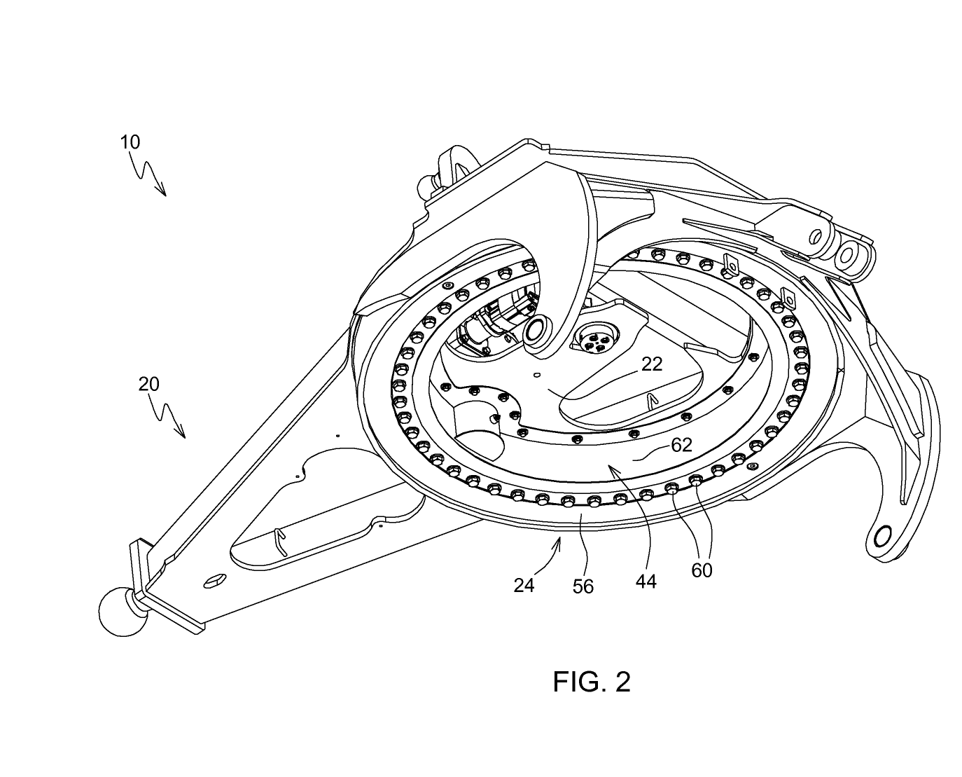

Referring to FIGS. 1 and 2, a draft apparatus 10 is provided for a motor grader. The motor grader comprises a front section and a rear section. The front and rear sections are coupled to one another for articulation about an articulation axis. The front section 12 comprises a main frame, an operator's station mounted to the main frame, and the draft apparatus 10 connected to the main frame.

The draft apparatus 10 comprises a draft frame 20. The draft frame 20 is coupled to the main frame via, for example, a spherical joint at the front of the draft frame 20. The draft frame 20 widens as it extends rearwardly to a platform 22 of the draft frame 20.

The draft apparatus 10 comprises a circle 24. The circle 24 comprises a circle gear 26. The circle 24 is connected to the draft frame 20 for rotation relative to the draft frame 20 about an axis 28 of the circle gear 26.

The draft apparatus 10 comprises a moldboard 30. The moldboard 30 is mounted to the circle 24 for rotation therewith about the axis 28. The front section comprises a tilt frame 32 connected pivotally to the circle 24 for pivotal movement of the tilt frame 32 relative to the circle 24 in response to operation of a hydraulic tilt cylinder (not shown). The moldboard 30 is held by the tilt frame 32 and is side-shiftable relative to the tilt frame 32 in response to operation of a first side-shift cylinder (not shown).

A saddle is mounted to the main frame. Left and right lift cylinders are mounted to the saddle 32 and the draft frame 20 for raising and lowering respectively the lateral sides of the draft frame 20, and thus the moldboard 30, relative to the main frame. A second side-shift cylinder is connected to the saddle 32 and the draft frame 20 to side-shift the draft frame 20, and thus the moldboard 30, relative to the main frame.

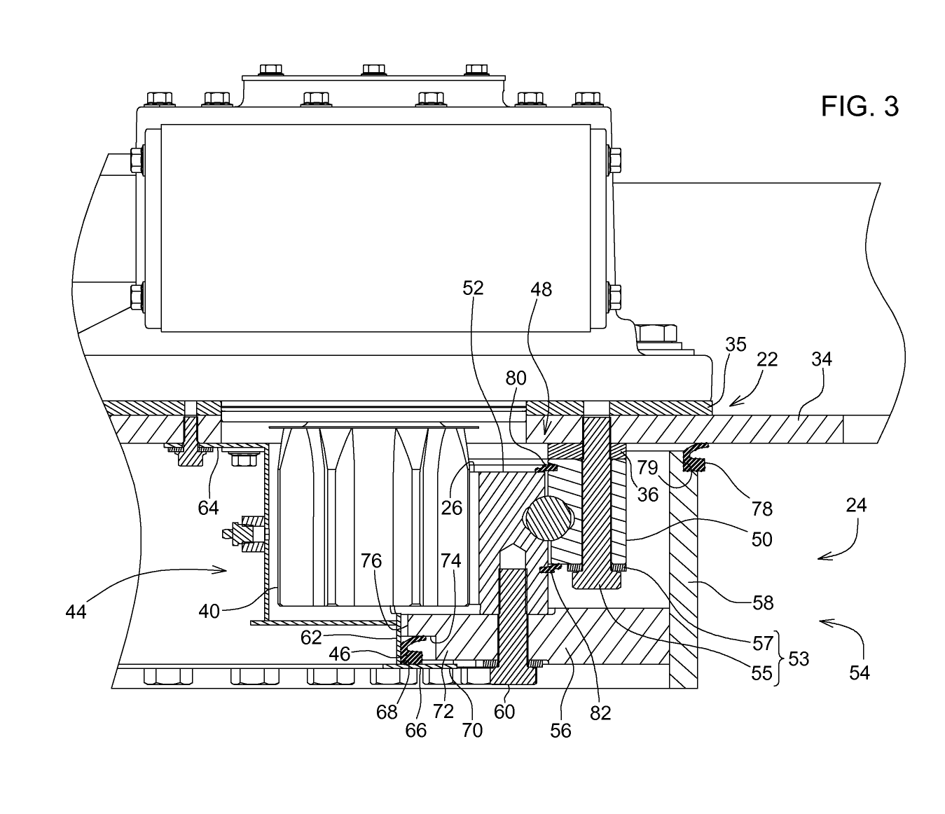

Referring to FIGS. 1 and 3, the draft apparatus 10 comprises a circle drive 38. The circle drive 38 is mounted to the draft frame 20 and comprises a pinion 40 engaging the circle gear 26 to rotate the circle 24 and the moldboard 30 about the axis 28.

In an example, the circle drive 26 comprises a dual-worm circle drive gearbox 42. The gearbox 42 is mounted to the platform 22. The pinion 40 is mounted to an output of the gearbox 42 to rotate therewith. An example of such a dual-worm circle drive gearbox 42 is disclosed in U.S. Patent Application Publication No. 20120073890A1, the disclosure of which is hereby incorporated by reference herein.

Referring to FIGS. 2 and 3, the draft apparatus 10 comprises an annular guard 44. The guard 44 depends from the draft frame 20 so as to provide radial cover of the circle gear 26 and the pinion 40 relative to the axis 28, inhibiting ingress of contamination thereto. Illustratively, the guard 44 covers the circle gear 26 and the pinion 40 radially inwardly relative to the axis 28.

Referring to FIG. 3, the draft apparatus 10 comprises an annular first seal 46. The first seal 46 establishes a sealed connection between the guard 44 and the circle 24, inhibiting passage of contamination therebetween. The first seal 46 may underlie the pinion 40, promoting compactness in the circle area of the draft apparatus 10. The first seal 46 may be, for example, a lip seal or other suitable type of seal, and it may be made, for example, of nitrile rubber.

The draft apparatus 10 may comprise a slew bearing 48. In such a case, the slew bearing 48 comprises an outer ring 50, an inner ring 52 radially inward of the outer ring 50 relative to the axis 28, and rolling elements positioned radially therebetween relative to the axis 28. By inhibiting passage of contamination between the guard 44 and the circle 24, the seal 46 inhibits ingress of contamination into the interface between the pinion and the circle gear. The slew bearing is, for example, a ball-roller slew bearing. It may be another type of suitable slew bearing (e.g., cross-roller slew bearing).

The platform 22 comprises, for example, a first or base plate 34, a second or support plate 35, and an annular third or mounting plate 36. The base plate 34 is positioned between and connected to (e.g., welded) the support plate 35 and the mounting plate 36.

Illustratively, the outer ring 50 is mounted to the draft frame 20. The outer ring 50 may be so mounted via a ring of fasteners 53 connecting the outer ring 50 to the platform 22. The outer ring 50 abuts the annular mounting plate 36 such that the mounting plate 36 provides a mounting surface for the outer ring 50 around the axis of rotation of the slew bearing 48. Each fastener 53 comprises a threaded bolt 55 and a washer 57 sandwiched between the head of the bolt 55 and the outer ring 50. The bolt 55 is threaded to the mounting plate 36 and the main plate 34 (the support plate 34 may also be threaded depending on the length of the bolt 55). The inner ring 52 comprises the circle gear 26 and is rotatable about the axis 28 relative to the outer ring 50.

The circle 24 comprises a circle frame 54. The circle frame 54 comprises an annular radial frame wall 56 extending radially relative to the axis 28 and an annular axial frame wall 58 extending axially relative to the axis 28. The frame walls 56, 58 are connected to one another (e.g., welded) such that the radial frame wall 56 extends radially inwardly from the axial frame wall 58. The radial frame wall 56 is mounted to the inner ring 52. For example, the radial frame wall 56 is fastened to the inner ring 52 with a ring of fasteners 60 (e.g., threaded bolts and associated washers). The seal 46 establishes a sealed connection between the guard 44 and the radial frame wall 56.

The guard 44 comprises an annular axial guard wall 62, an annular first radial guard wall 64, and an annular second radial guard wall 66. The axial guard wall 62 extends axially relative to the axis 28.

The first and second radial guard walls 64, 66 extend radially relative to the axis 28. For example, the first and second radial guard walls 64, 66 extend respectively radially inwardly and radially outwardly from the axial guard wall 62 relative to the axis 28. The axial guard wall 62 is connected (e.g., welded) to the first and second radial guard walls 64, 66 therebetween. The axial guard wall 62 has a pinion-receiving portion that protrudes radially inwardly relative to the axis 28 and receives the pinion 40 therein. The walls 62, 64, 66 may be configured, for example, as sheets of metal.

The seal 46 is positioned between the guard 44 and circle frame 54. For example, the seal 46 is positioned in a corner recess 68 formed between the axial guard wall 62 and the radial guard wall 66 such that the seal 46 contacts the axial guard wall 62, the radial guard wall 66, and the radial frame wall 56. The seal 46 is positioned on the radial guard wall 66.

A portion 70 of the guard 44 and a portion 72 of the circle 24 cooperate to define a region of axial overlap relative to the axis 28. As such, the portion 70 of the guard 44 and the portion 72 of the circle 24 are positioned in overlapping relation to one another relative to the axis 28. The seal 46 is positioned in the region of axial overlap. The region of axial overlap keeps out larger debris and promotes protection of the seal 46.

The radial frame wall 56 comprises, for example, an annular end notch 74 in an end corner of the radial frame wall 56. The guard 44 and the radial frame wall 56 of the circle 24 cooperate to define a labyrinth 76. The seal 46 is positioned in the labyrinth 76, and contacts the end notch 74. The seal 46 is positioned radially inwardly from the ring of fasteners 60 relative to the axis 28.

The draft apparatus 10 comprises an annular second seal 78. The seal 78 establishes a sealed connection between the circle 24 and the draft frame 20, inhibiting passage of contamination therebetween. The seal 78 contacts the axial frame wall 58 and the platform 22 of the draft frame 20. The axial frame wall 58 comprises, for example, an annular end notch 79 in an end corner of the wall 58. The seal 78 is positioned in that end notch 79. The seal 78 may be, for example, a lip seal or other suitable type of seal, and it may be made, for example, of nitrile rubber.

The draft apparatus 10 is configured to provide protection to the gear mesh between the pinion 40 and the circle gear 26 and to the slew bearing 48 against contamination. The guard 44, the circle frame 54, and the seals 46, 78 cooperate to provide a closed design to serve this purpose. Otherwise, ingress of contamination into the gear mesh and the slew bearing 48 could result in accelerated wear in those areas. The first seal 46 inhibits ingress of debris to the gear mesh and to an upper slew seal 80 of the slew bearing 48 for their protection, and helps to retain lubricant (e.g., grease) for lubrication of the gear mesh. The second seal 78 inhibits ingress of debris to a lower slew seal 82 of the slew bearing 48 for its protection. The seals 80, 82 may be made, example, of rubber (possibly nitrile rubber).

In other embodiments, the slew bearing 48 may be configured such that its inner ring is fastened to the draft frame 20, and the outer ring comprises the circle gear 26. In such a case, the guard 44 may be arranged so as to cover the circle gear 26 and the pinion 40 radially outwardly relative to the axis 28.

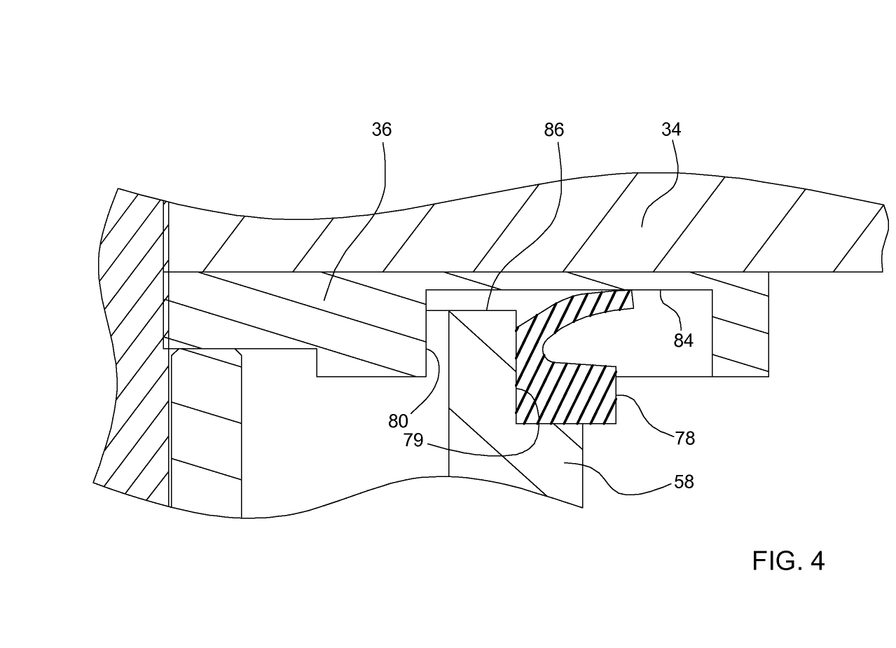

Referring to FIG. 4, in another embodiment of the platform 22, the platform 22 comprises an annular recess 84. In this embodiment, the mounting plate 36 of the platform 22 extends radially outward so as to include the recess 84. The axial frame wall 58 extends into the recess 84 so as to terminate therein, such that the wall 58 and the radially extended mounting plate 36 cooperate to define a labyrinth 86. The second seal 78 is positioned in the recess 84 and the labyrinth 86, and contacts the recess 84. The labyrinth 86 inhibits ingress of debris to the lower slew seal 82 for its protection.

The welds, threads, and hydraulic and electrical lines of the draft apparatus 10 have not been shown for simplification of illustration, it being understood that it would be well within the skill of one of ordinary skill in the art to provide those elements without undue experimentation.

While the disclosure has been illustrated and described in detail in the drawings and foregoing description, such illustration and description is to be considered as exemplary and not restrictive in character, it being understood that illustrative embodiment(s) have been shown and described and that all changes and modifications that come within the spirit of the disclosure are desired to be protected. It will be noted that alternative embodiments of the present disclosure may not include all of the features described yet still benefit from at least some of the advantages of such features. Those of ordinary skill in the art may readily devise their own implementations that incorporate one or more of the features of the present disclosure and fall within the spirit and scope of the appended claims.

What is claimed is:

1. A draft apparatus for a motor grader, comprising
a draft frame,
a circle comprising a circle gear, the circle connected to the draft frame for rotation relative to the draft frame about an axis of the circle gear,
a moldboard mounted to the circle for rotation therewith about the axis,
a circle drive mounted to the draft frame and comprising a pinion engaging the circle gear to rotate the circle and the moldboard about the axis,
a guard depending from the draft frame so as to provide radial cover of the circle gear and the pinion relative to the axis, and
a seal establishing a sealed connection between the guard and the circle.

2. The draft apparatus of claim 1, wherein the guard covers the circle gear and the pinion radially inwardly relative to the axis.

3. The draft apparatus of claim 2, comprising a slew bearing, wherein the slew bearing comprises an outer ring and an inner ring radially inward of the outer ring relative to the axis, the outer ring is mounted to the draft frame, the inner ring comprises the circle gear and is rotatable about the axis relative to the outer ring, the circle comprises an annular radial frame wall extending radially relative to the axis and mounted to the inner ring, the seal establishes a sealed connection between the guard and the radial frame wall.

4. The draft apparatus of claim 3, wherein the guard comprises an annular axial guard wall extending axially relative to the axis and an annular radial guard wall extending radially outwardly from the axial guard wall relative to the axis, the seal is positioned in a corner formed between the axial guard wall and the radial guard wall such that the seal contacts the axial guard wall, the radial guard wall, and the radial frame wall.

5. The draft apparatus of claim 4, wherein the radial frame wall comprises an end notch, and the seal contacts the end notch.

6. The draft apparatus of claim 4, wherein the seal is a first seal, the draft apparatus comprises a second seal, the circle comprises an annular axial frame wall extending axially relative to the axis, the radial frame wall extends radially inwardly from the axial frame wall, and the second seal contacts the axial frame wall and the draft frame establishing a sealed connection therebetween.

7. The draft apparatus of claim 6, wherein the draft frame comprises a mounting plate, the outer ring is fastened to the mounting plate, the mounting plate comprises a recess into which the axial frame wall extends such that the axial frame wall and the recess cooperate to define a labyrinth, the second seal contacts the axial frame wall and the recess establishing a sealed connection therebetween.

8. The draft apparatus of claim 3, wherein the radial frame wall is fastened to the inner ring with a ring of fasteners, and the seal is positioned radially inwardly from the ring of fasteners relative to the axis.

9. The draft apparatus of claim 2, comprising a slew bearing, wherein the slew bearing comprises an outer ring and an inner ring radially inward of the outer ring relative to the axis, the inner ring comprises the circle gear and is rotatable about the axis relative to the outer ring, the draft frame comprises a platform, the circle comprises a circle frame, the outer ring is mounted to the platform, the platform comprises a recess into which a portion of the circle frame extends such that the portion of the circle frame and the recess cooperate to define a labyrinth, the seal is a first seal, and the draft apparatus comprises a second seal contacting the portion of the circle frame and the recess establishing a sealed connection therebetween.

10. The draft apparatus of claim 1, wherein the guard comprises an annular radial guard wall extending radially relative to the axis, and the seal is positioned on the radial guard wall.

11. The draft apparatus of claim 10, wherein the guard comprises an annular axial guard wall extending axially relative to the axis, the radial guard wall extends radially outwardly from the axial guard wall relative to the axis, the seal is positioned in a corner recess formed between the axial guard wall and the radial guard wall such that the seal contacts the axial guard wall and the radial guard wall.

12. The draft apparatus of claim 1, wherein a portion of the guard and a portion of the circle cooperate to define a region of axial overlap relative to the axis, and the seal is positioned in the region of axial overlap.

13. The draft apparatus of claim 1, wherein the guard and the circle cooperate to define a labyrinth, and the seal is positioned in the labyrinth.

14. The draft apparatus of claim 1, wherein the seal underlies the pinion.

15. The draft apparatus of claim 1, wherein the seal is a first seal, and the draft apparatus comprises a second seal establishing a sealed connection between the circle and the draft frame.

16. The draft apparatus of claim 1, wherein the seal is a lip seal.
